(19) United States
(12) Patent Application Publication
(10) Pub. No.: US 2004/0257209 A1
(43) Pub. Date: Dec. 23, 2004

(54) Auto anti-thief system employing bluetooth technique

(76) Inventor: Wu-Chung Yang, Kaohsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/650,706

(22) Filed: Aug. 29, 2003

Related U.S. Application Data
(63) Continuation-in-part of application No. 10/463,337, filed on Jun. 18, 2003, now abandoned.

(51) Int. Cl. B60R 25/10

(52) U.S. Cl. 340/426.13

(57) ABSTRACT

An auto anti-thief system employing a bluetooth technique is provided. The anti-thief system includes a system core processor, a bluetooth communication module, an anti-thief alarm control circuit, an indicator control circuit, a door lock initiator control circuit and a power voltage regulator circuit. When cooperating the present invention with the bluetooth communication module built in the mobile phone, it can reduce the loading of carrying the remote controller for the user. Moreover, through the frequency hopping used by the wireless channel of bluetooth, it will not be interfered easily. Furthermore, utilizing 128 bits to protect the encoding method, the security is more increased. Therefore, the present invention breaks through the unidirectional transmission employed by the conventional remote controller. Thus, after confirming the identification between the bluetooth mobile phone of the user and the anti-thief system through the bi-directional transmission and data transmission, the door lock can be immediately relieved and the user can easily and conveniently drive the car.

### CROSS-REFERENCES TO RELATED APPLICATIONS

The present invention is a Continuation-in-part (CIP) application of a pending non-provisional patent application with application Ser. No. 10/463,337 filed Jun. 18, 2003.

### BACKGROUND OF THE INVENTION

1. Field of the Invention

The present invention relates to an auto anti-thief system employing a bluetooth technique, and more particular to a bluetooth technique which has a frequency-hopping of 1600 times per second between 2400˜2483.5 MHz, a change way of 1 MHz frequency spacing each time and a bi-directional and extremely secured 128 bits code so that the user can set the distance for controlling the remote controller by himself so as to realize a wireless non-contact key considering both the convenience and the security.

2. Description of the Prior Art

Although the remote controller becomes smaller and smaller in volume and in weight owing to the developing technique, the number of the keys and the remote controllers becomes more and more without effective integrating and also becomes more inconvenient for the user to carry. However, because the car becomes more and more important in modem life, the user still has to employ the remote controller to control the door lock and the anti-thief system even the inconvenience thereof. For example, when shopping, the hands holding many bags still has to look for the remote controller to relieve the anti-thief system and the door lock, or the problem that the remote controller might be copied owing to the opportunity of handing the remote controller to some one else for car maintaining or car washing. The problems described above have exactly caused a quite loading to modem people.

Presently, the conventional anti-thief system utilizes a low-cost and easy to be interfered low frequency or a high-cost high frequency to achieve the function of anti-thief warming, door locking or reliving. But, in common, the defect of the two is that they own only one function. They can only achieve the function of anti-thief warming, door locking or reliving and cannot be expanded to own other functions. If the cost thereof is considered so as to utilize the low frequency, it will not be able to have a bi-directional and rigorous security.

Now, the mobile phone which also belongs to the wireless product gradually becomes the daily necessary for the modem people, and simultaneously, the bluetooth wireless communication technique also becomes matured. Consequently, how to integrate the bluetooth with the auto anti-thief system for increase the convenience in life becomes an important subject.

Thus it can be seen, the prior art described above still has some defects, is not a good design, however, and is urgently to be improved.

Because of the technical defects of described above, the applicant keeps on carving unflaggingly to develop the auto anti-thief system employing a bluetooth technique through wholehearted experience and research.

### SUMMARY OF THE INVENTION

An object of the present invention is to provide an auto anti-thief system employing a bluetooth technique which utilizes the bi-directional transmission function of the bluetooth to replace the remote controller for the conventional anti-thief system which only has the unidirectional data transmission so that the user is no longer using the key on the remote controller for turning on and turning off the anti-thief system. Furthermore, because of the encoding method of the present invention is more rigorous, the security and the reliability are more increased.

Another object of the present invention is to provide an auto anti-thief system employing a bluetooth technique thereby the convenience for the user can be increased and the auto anti-thief system also can be more humanized. Henceforward, the user doesn't need to carry another additional remote controller and still can achieve the purpose of automatically turning on the anti-thief system when turning off the car and leaving. And, the anti-thief system can be automatically turned off when the user approaches the car and readies to drive. Thus, the user is no longer worrying whether the anti-thief system is turned on or not so that the purpose of wireless key can be achieved.

Another further object of the present invention is to provide an auto anti-thief system employing a bluetooth technique so that the user can set the distance for controlling the anti-thief system by himself. If the user hopes to relieve the door lock fast, the distance can be set to be longer, and if the user worries an invasion of an evildoer, the distance can be set to be shorter.

Additional object of the present invention is to provide an auto anti-thief system employing a bluetooth technique thereby after the anti-thief mainframe and the mobile phone are authorized to each other as firstly installed by the user, the user would not need to worry the problem of remote control and the trouble that the remote controller might be copied.

Additional further object of the present invention is to provide an auto anti-thief system employing a bluetooth technique whose setting or remove can be processed by the bluetooth mobile phone through an induction way or through manually pressing a key thereof.

For achieving the purposes described above, the auto anti-thief system employing the bluetooth technique according to the present invention includes a system core processor, a bluetooth communication module, an anti-thief alarm control circuit, an indicator control circuit, a door lock initiator control circuit and a power voltage regulator circuit. When the anti-thief system according to the present invention detects the bluetooth mobile phone carried by the user enters the communication coverage of the bluetooth, the identification is immediately authorized, and after confirming the identification, the data begins to exchange. When the signal intensity achieved a user-set intensity, the anti-thief system will automatically turn off. Oppositely, when the car is turned off and the user leaves the car, the signal intensity will be lower than the user-set intensity and the anti-thief system will immediately turn on.

### BRIEF DESCRIPTION OF THE DRAWINGS

The drawings disclose an illustrative embodiment of the present invention which serves to exemplify the various advantages and objects hereof, and are as follows:

FIG. 1 shows a circuit block diagram of an auto anti-thief system employing a bluetooth technique according to the present invention; and

FIG. 2 shows a practicing circuit diagram of an auto anti-thief system employing a bluetooth technique according to the present invention.

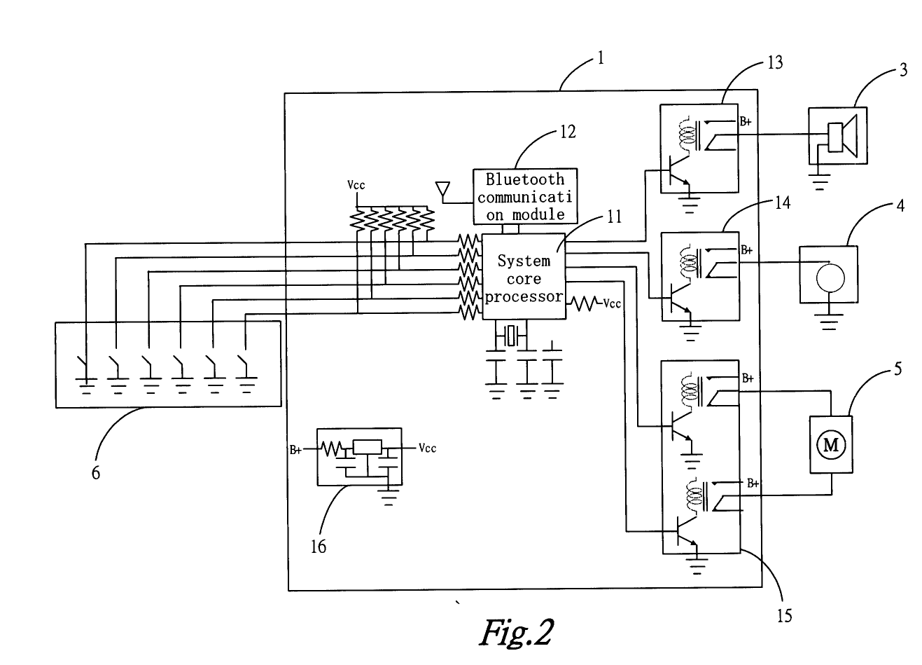

### DETAILED DESCRIPTION OF THE PREFERRED EMBODIMENT

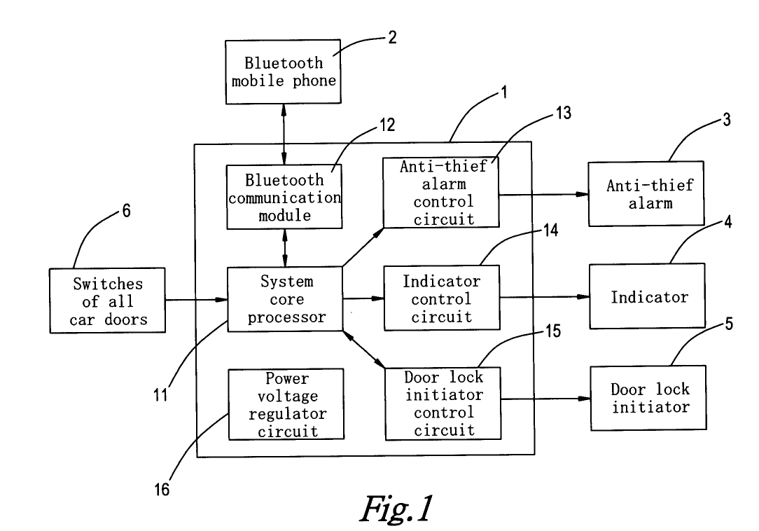

Please refer to FIGS. 1 & 2 which respectively show a circuit block diagram and a practicing circuit diagram of an auto anti-thief system employing a bluetooth technique according to the present invention. As shown in FIGS. 1 & 2, the auto anti-thief system 1 employing the bluetooth technique at least includes:

a system core processor 11 bridged to a bluetooth communication module 12, an anti-thief alarm control circuit 13, an indicator control circuit 14, a door lock initiator control circuit 15, and switches 6 of all car doors for receiving each inputted control signal thereof and transmitting the control signal to each output device after the control signal being processed, converted and compared;

a bluetooth communication module 12 bridged to the system core processor 11 and having a frequency-hopping of 1600 times per second between 2400˜2483.5 MHz, a change way of 1 MHz frequency spacing each time and a bi-directional and extremely secured 128 bits code so as to bi-directionally transmit with the bluetooth mobile phone 2;

an anti-thief alarm control circuit 13 for receiving the control signal from the system core processor 11 and controlling a timely action of an anti-thief alarm 3;

an indicator control circuit 14 for receiving the control signal from the system core processor 11 and controlling an action of an indicator 4;

a door lock initiator control circuit 15 for receiving the control signal from the system core processor 11, controlling an action of a door lock initiator 5 and reporting back the condition of the door lock initiator 5 to the system core processor 11; and

a power voltage regulator circuit 16 for converting a power in a car into a steady voltage so as to provide a power to the whole auto anti-thief system;

wherein when the car is turned off and the user leaves the car and the signal intensity of the bluetooth mobile phone 2 carried by the user is lower than a user-set intensity, the anti-thief system 1 will automatically turn on. Therefore, the door lock initiator control circuit 15 drives the door lick initiator 5 to lock all car doors, the anti-thief alarm control circuit 13 drives the anti-thief alarm 3 to beep, and the indicator control circuit 14 drives the indicator to flash for presenting that the anti-thief system is turned on. Oppositely, when the user approaches the car and the signal intensity of the bluetooth mobile phone 2 carried by the user is higher than the user-set intensity, the anti-thief system 1 will immediately turn off. Thus, the door lock initiator control circuit 15 drives the door lick initiator 5 to open all door locks, the anti-thief alarm control circuit 13 drives the anti-thief alarm 3 to beep, and the indicator control circuit 14 drives the indicator to flash for presenting that the anti-thief system is turned off.

Besides utilizing the bluetooth mobile phone to achieve an induction setting or remove of the anti-thief system, the anti-thief system employing the bluetooth technique also can directly achieve the setting or remove by the user through pressing the key of the bluetooth mobile phone.

When the bluetooth mobile phone is not carried by the user or runs out of electricity, the anti-thief system can be operated by a manual operation to be turned on and turned off.

The setting steps thereof includes:

1. Turning off the car under a starting condition;

2. Opening the driver's door and then closing thereof; and

3. Relieving the door lock and then locking thereof again so that the anti-thief will automatically turn on,

wherein the door lock initiator control circuit drives the door lock initiator to lock all car doors, the anti-thief alarm control circuit drives the anti-thief alarm to beep, and the indicator control circuit drives the indicator to flash for representing that the anti-thief system is turned on.

The removing steps thereof includes:

1. The car is under the anti-thief setting mode;

2. Opening the locked car doors;

3. Opening the closed driver's door and then closing thereof again; and

4. Automatically initiating the anti-thief system within five seconds,

wherein the door lock initiator control circuit drives the door lick initiator to open all door locks, the anti-thief alarm control circuit drives the anti-thief alarm to beep, and the indicator control circuit drives the indicator to flash for presenting that the anti-thief system is turned off.

The auto anti-thief system employing the bluetooth technique according to the present invention, when being compared with the other prior arts, further includes the advantages as follows:

1. The anti-thief mainframe according to the present invention includes the bluetooth communication module, so that after the anti-thief mainframe and the mobile phone are authorized to each other as firstly installed by the user, the user would not need to worry the problem of remote control and the trouble that the remote controller might be copied.

2. After the anti-thief mainframe according to the present invention is installed, the user can immediately experience the convenience. Henceforward, the user doesn't need to carry another additional remote controller and still can achieve the purpose of automatically turning on the anti-thief system when turning off the car and leaving. And, the anti-thief system can be automatically turned off when the user approaches the car and readies to drive.

3. The bluetooth communication module set in the anti-thief mainframe according to the present invention includes a complex distance calculating codes so that the user can set the distance for turning on and turning off the anti-thief system.

4. The present invention also considers the situation that the mobile phone runs out of electricity or is not carried by the user. Under this condition, the anti-thief system still can be turned on and turned off through the manual operation. Furthermore, the security will still be maintained because it has to pass through two outposts, the car door lock and the drive lock. Therefore, it needs the key to turn on and turn off the anti-thief mainframe of anti-thief system.

5. The setting or remove of auto anti-thief system employing the bluetooth technique according to the present invention can be processed by the bluetooth mobile phone through an induction way or through manually pressing a key thereof.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. An auto anti-thief system employing a bluetooth technique, comprising:
a system core processor bridged to a bluetooth communication module, an anti-thief alarm control circuit, an indicator control circuit, and a door lock initiator control circuit for receiving each inputted control signal thereof and transmitting said control signal to each output device after said control signal being processed, converted and compared;
a bluetooth communication module bridged between a bluetooth mobile phone and said system core processor for confirming a data therebetween through a bidirectional transmission;
an anti-thief alarm control circuit for receiving said control signal from said system core processor and controlling a timely action of an anti-thief alarm;
an indicator control circuit for receiving said control signal from said system core processor and controlling an action of an indicator;
a door lock initiator control circuit for receiving said control signal from said system core processor, controlling an action of a door lock initiator and reporting back the condition of said door lock initiator to said system core processor; and
a power voltage regulator circuit for converting a power in a car into a steady voltage so as to provide a power to said auto anti-thief system;
thereby when being firstly set, said auto anti-thief system communicates with said bluetooth mobile phone through said bluetooth communication module, and thus said car enters an anti-thief setting mode or an anti-thief remove mode only by a wireless communication without a manual operation.

2. The auto anti-thief system employing bluetooth technique according to claim 1, wherein said auto anti-thief system utilizes said bluetooth technique, and after a confirmation between said anti-thief system and said bluetooth mobile phone, a user is capable of setting a control distance by himself via an emitting and receiving intensity of radio waves.

3. An auto anti-thief system employing a bluetooth technique, comprising:
a system core processor bridged to a bluetooth communication module, an anti-thief alarm control circuit, an indicator control circuit, and a door lock initiator control circuit for receiving each inputted control signal thereof and transmitting said control signal to each output device after said control signal being processed, converted and compared;
a bluetooth communication module bridged between a bluetooth mobile phone and said system core processor for confirming a data therebetween through a bi-directional transmission;
an anti-thief alarm control circuit for receiving said control signal from said system core processor and controlling a timely action of an anti-thief alarm;
an indicator control circuit for receiving said control signal from said system core processor and controlling an action of an indicator;
a door lock initiator control circuit for receiving said control signal from said system core processor, controlling an action of a door lock initiator and reporting back the condition of said door lock initiator to said system core processor; and
a power voltage regulator circuit for converting a power in a car into a steady voltage so as to provide a power to said auto anti-thief system;
thereby when being firstly set, a setting or a remove of said anti-thief system is directly controlled by a key of said bluetooth mobile phone.

4. The auto anti-thief system employing bluetooth technique according to claim 1 or 3, wherein when said bluetooth mobile phone is not working, a logic procedure is employed to enter said anti-thief setting mode or said anti-thief remove mode by said manual operation through two outposts via the car key.

5. The auto anti-thief system employing bluetooth technique according to claim 4, wherein said manual operation for setting said anti-thief system comprises steps of:
step 1: turning off a starting car;
step 2: opening the driver's door and closing it;
step 3: locking a relieved door lock so as to automatically turn on said anti-thief system,
wherein said door lock initiator control circuit drives said door lock initiator to lock all car doors, said anti-thief alarm control circuit drives said anti-thief alarm to beep, and said indicator control circuit drives said indicator to flash for presenting that said anti-thief system is turned on.

6. The auto anti-thief system employing bluetooth technique according to claim 4, wherein said manual operation for removing said anti-thief system comprises steps of:
step 1: said car is under said anti-thief setting mode;
step 2: relieving a locked door lock;
step 3: opening the closed driver's door and closing thereof again;
step 4: automatically turning off said anti-thief system when said car is initiated within five seconds,
wherein said door lock initiator control circuit drives said door lick initiator to open all door locks, said anti-thief alarm control circuit drives said anti-thief alarm to beep, and said indicator control circuit drives said indicator to flash for presenting that said anti-thief system is turned off.
